(19) United States
(12) Patent Application Publication
(10) Pub. No.: US 2007/0158934 A1
(43) Pub. Date: Jul. 12, 2007

(54) Membrane for a vehicle occupant protection apparatus

(75) Inventors: Ying-Kuo Lee, Troy, MI (US); Amy J. Niesluchowski, Gilbert, AZ (US); Kirk E. Short, Gilbert, AZ (US); Kwen Hsu, Rochester Hills, MI (US); Darrin L. Johnson, Fountain Hills, AZ (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/330,804

(22) Filed: Jan. 12, 2006

(51) Int. Cl. B60R 21/26

(52) U.S. Cl. 280/737

(57) ABSTRACT

An apparatus (10) includes a housing (22) containing a fluid (32) at a first pressure. A portion of the housing (22) includes a nickel-based alloy. The nickel-based alloy has a strain hardening index less than about 0.2. In one embodiment, the housing (22) has an outflow opening (42) closed by a membrane (44). A surface (110) of the membrane (44) extends across the opening (42) and includes a plurality of indentations (130).

### FIELD OF THE INVENTION

The present invention relates to an apparatus for storing a fluid under pressure, and, more particularly, to a membrane for an apparatus that stores a fluid for actuating a vehicle occupant protection device.

### BACKGROUND OF THE INVENTION

An inflator for actuating a vehicle occupant protection device can include a quantity of a stored fluid (e.g., stored gas) and a combustible material stored in an inflator housing. An igniter is actuatable to ignite the combustible material. As the combustible material burns, the combustion products heat the stored gas. The heated stored gas and the combustion products form an inflation fluid for actuating the vehicle occupant protection device.

The inflator housing can include a rupturable membrane that opens to discharge the inflation fluid from the housing. Discharge of the inflation fluid from the inflator actuates (e.g., inflates) the vehicle occupant protection device. The membrane can open when the inflation fluid in the housing reaches a predetermined pressure and/or temperature.

The rupturable membrane can be a burst disc that is formed from an alloy. One example of an alloy that can be used to form a burst disc for an inflator is INCONEL 625, which is commercially available from Special Metals Corporation (New Hartford, N.Y.). INCONEL 625 consists essentially of, by weight, up to about 5% iron, about 20% to about 23% chromium, about 8% to about 10% molybdenum, about 3.15% to about 4.15% combined niobium and tantalum, up to about 0.5% manganese, up to about 0.5% silicon, up to about 0.4% aluminum, up to about 0.4% titanium, up to about 0.1% carbon, up to about 0.015% sulfur, up to about 0.015% phosphorous, up to about 0.02% nitrogen, up to about 0.3% copper, and the balance nickel.

### SUMMARY OF THE INVENTION

The present invention relates to an apparatus for actuating a vehicle occupant protection device. The apparatus comprises a housing having a chamber containing a fluid at a first pressure. An outflow opening is provided in the housing through which the fluid can flow from the housing to actuate the vehicle occupant protection device. A membrane having a first temperature closes the opening. The membrane includes a surface extending across the opening. The surface includes a plurality of indentations concentrically arranged relative to a center of the surface. Each indentation can have a substantially polygonal shape and be separated from each other indentation on the surface of the membrane.

The indentations can promote rupturing of the membrane when the membrane reaches an elevated temperature and/or the fluid reaches an elevated pressure. In an aspect of the invention, the indentations can have an average depth. The average depth can be about 1% to about 10% of a thickness of the membrane.

Another aspect of the invention relates to an apparatus that comprises a housing, which contains a fluid at a first pressure. A portion of the housing comprises a nickel-based alloy having a hardening index at temperatures of about 900° C. to about 1200° C. defined by:
σ=κεⁿ
where σ is the true stress of the nickel-based alloy, ε is the true plastic strain of the nickel-based alloy, κ is a material constant of the alloy, and n is the strain hardening index of the nickel-based alloy. The strain hardening index in accordance with this aspect is less than about 0.2. A membrane formed from a nickel-based alloy with a strain hardening index less than about 0.2 exhibits nearly perfect plastic deformation behavior at temperatures of about 900° C. to about 1200° C.

In an aspect of the invention, the microstructure of the nickel-based alloy can be substantially free of sigma phase and mu phase at temperatures above about 900° C.

In another aspect of the invention, the nickel-based alloy can comprise, by weight, at least about 50 nickel, at least about 20% chromium, up to about 3% molybdenum, and at least about 10% tungsten.

In a further aspect of the invention, the nickel-based alloy can comprise, by weight, up to about 5% cobalt, up to about 0.3% iron, about 20% to about 24% chromium, about 1% to about 3% molybdenum, about 13% to about 15% tungsten, about 0.3% to about 1% manganese, about 0.25 to about 0.75% silicon, about 0.2% to about 0.5% aluminum, about 0.05% to about 0.15% carbon, up to about 0.015% sulfur, up to about 0.03% phosphorous, and the balance substantially nickel.

In yet another aspect of the invention, the nickel-based alloy can consist essentially of, by weight, up to about 5% cobalt, up to about 0.3% iron, about 20% to about 24% chromium, about 1% to about 3% molybdenum, about 13% to about 15% tungsten, about 0.3% to about 1% manganese, about 0.25 to about 0.75% silicon, about 0.2% to about 0.5% aluminum, about 0.05% to about 0.15% carbon, up to about 0.015% sulfur, up to about 0.03% phosphorous, up to about 0.25% residual elements, and the balance nickel.

### BRIEF DESCRIPTION OF THE DRAWINGS

The foregoing and other features of the invention will become more apparent to one skilled in the art upon consideration of the following description of the invention and the accompanying drawings in which:

FIG. 1 illustrates a schematic view of a vehicle occupant protection apparatus in accordance with an aspect of the present invention;

FIG. 2 illustrates a schematic view of an inflator in accordance with an aspect of the invention;

FIG. 3 illustrates a sectional view of a membrane of the apparatus of FIG. 2;

FIG. 4 illustrates a perspective view of the membrane of FIG. 3;

FIG. 5 illustrates sectional view of the membrane of FIG. 3 in an open configuration;

FIG. 6 illustrates a method of producing the membrane of FIG. 4 in accordance with an aspect of the invention;

FIG. 7 illustrates a plot of the ultimate tensile strength and yield strength as a function of temperature for a nickel-based alloy in accordance with an aspect of the invention;

FIG. 8 illustrates a plot of the ultimate tensile strength and yield strength as function of temperature for a nickel-based alloy in accordance with another aspect of the invention; and

FIG. 9 illustrates a plot comparing the true plastic strain and true stress for nickel based alloys in accordance with an aspect of the invention.

### DESCRIPTION OF PREFERRED EMBODIMENT

The present invention relates to a membrane that can be used to close an outflow opening of a housing. The membrane can have a first temperature. The housing can include a chamber that contains a stored fluid and the membrane can maintain the stored fluid in the chamber at a first pressure. When the pressure of the stored fluid increases to an elevated pressure (e.g., about 24 MPa to about 100 MPa) and/or the membrane reaches an elevated temperature (e.g., at least about 900° C.), the membrane plastically deforms and then ruptures to form an opening through which the stored fluid can flow. The membrane readily forms an opening in a controlled manner when the housing is exposed to ambient temperatures down to −35° C.

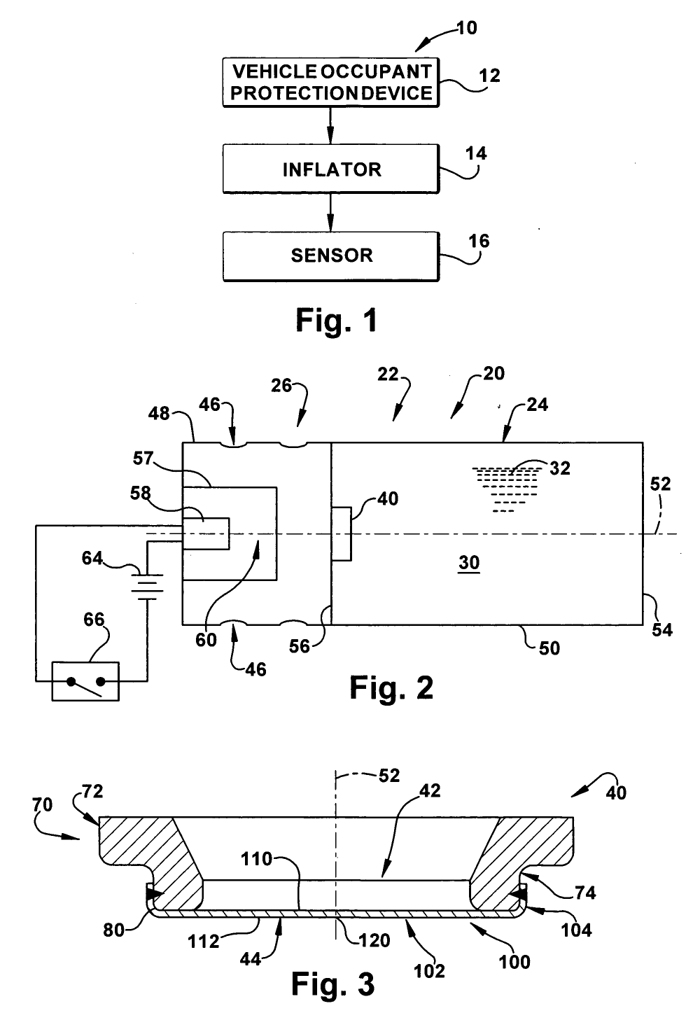

In an aspect of the invention, the housing can be part of an inflator of a vehicle occupant protection apparatus and be used for actuating a vehicle occupant protection device. FIG. 1 illustrates a schematic view of a vehicle occupant protection apparatus 10 in accordance with the present invention. The vehicle occupant protection apparatus 10 includes a vehicle occupant protection device 12. Examples of vehicle occupant protection devices 12 can include an inflatable device, such as an air bag, an inflatable seat belt, an inflatable knee bolster, an inflatable head liner, an inflatable side curtain, or a knee bolster operated by an air bag.

An inflator 14 is associated with the vehicle occupant protection device 12. The inflator 14 can be actuatable to direct fluid to the vehicle occupant protection device 12 to actuate (e.g., inflate) the vehicle occupant protection device 12.

The apparatus 10 also includes a sensor 16, such as a crash sensor. The crash sensor 16 is a known device that senses a vehicle condition, such as vehicle deceleration, indicative of a collision. When the crash sensor 16 senses a vehicle condition for which actuation of the vehicle occupant protection device is desired, the crash sensor 16 either transmits a signal or causes a signal to be transmitted to actuate the inflator 14. The inflator 14 actuates the vehicle occupant protection device to help protect a vehicle occupant from a forceful impact with parts of the vehicle.

FIG. 2 illustrates a schematic view of an exemplary inflator 20 in accordance with the invention. The inflator 20 includes a housing 22. The housing 22 includes a container 24, which is sometimes referred to as a bottle, and an end cap 26 that closes the container 24. The container 24 defines a storage chamber 30 containing a fluid 32 at a first pressure (or storage pressure). The end cap 26 includes a closure structure 40 that has an outflow opening 42 (FIG. 3) that is closed by a rupturable membrane 44 (FIG. 3) in accordance with the present invention. The end cap 26 is subjected to the pressure of the fluid 32 in the storage chamber 30 and blocks the fluid 32 from flowing out of the storage chamber 30. When the membrane 44 is ruptured, the stored fluid 32 is released to flow out of the storage chamber 30 past the ruptured membrane 44. The fluid then flows outward from the closure structure 40 through a plurality of outlet openings 46 in a diffuser 48.

An example of a container 24 in accordance with the present invention has an elongated generally annular wall 50 that extends along a central axis 52 between an end wall 54 and a circular open end 56 of the container 24, which is closed by the end cap 26. The container 24 can be formed from a metal that is typically used in pressure vessel formation. Such metals can include, for example, a stainless steel (e.g.,SS316), a low-carbon high strength steel (e.g., AISI 1513) as well as aluminum and/or an aluminum-based alloy (e.g., 6061 aluminum alloy). The container 24 formed from the metal will have a structural integrity that is substantially higher than the structural integrity of the membrane 44. Thus, when the inflator 20 is at an elevated pressure and/or elevated temperature, the membrane 44 will rupture prior to the container 24 rupturing.

The fluid 32 stored under pressure in the storage chamber 30 can comprise a fluid 32 that is typically used to inflate an inflatable vehicle occupant protection device, such as an air bag. For example, the fluid can comprise at least one inert gas, such as helium, nitrogen, and/or argon. The stored fluid can also include an oxidizer gas and/or a combustible fuel gas. The oxidizer gas can comprise, for example, oxygen. The fuel gas can comprise, for example, hydrogen, nitrous oxide, and/or methane.

The pressure at which the fluid is stored in the container (i.e., the first pressure) depends upon such factors as the volume of the inflatable vehicle occupant protection device 12 to be inflated, the time available for inflation, the inflation pressure desired, and the volume of the chamber 30 storing the gas. In an aspect of the invention, the fluid 32 can be stored at a pressure of about 12.5 MPa to about 55 MPa (e.g., about 20 MPa to about 27 MPa).

An end portion of the housing 20 supports a combustion chamber housing 57 and an actuatable pyrotechnic igniter 58. The combustion chamber housing 57 is aligned with the axis 52 and extends within the diffuser 48. The combustion chamber housing 57 includes a combustion chamber 60 that contains a readily ignitable gas generating material, such as a nitramine-based gas generating material, a guanidine-based gas generating material, and/or a nitroguanidine-based gas generating material. Other gas generating materials can also be used.

The igniter 58 contains an ignitable material (e.g., BKNO₃) (not shown) and functions to ignite the gas generating material in the combustion chamber 60. The igniter 58 is connected in an electrical circuit 62 that include a power source 64 (e.g., battery and/or capacitor) and a normally open switch 66. The switch 66 can be part of the crash sensor 16.

When the crash sensor 16 senses a vehicle condition for which actuation of the vehicle occupant protection device is desired, the switch 66 can close and the igniter is actuated electrically. The igniter 58 then ignites the gas generating material. Hot gas produced through deflagration of the gas generating material flows from the combustion chamber 60 and against the membrane to increase the temperature of the membrane from a first temperature (e.g., 25° C.) to an elevated temperature (e.g., at least about 900° C.). When the increasing membrane temperature reaches the elevated temperature, the membrane 44 plastically deforms in a controlled manner and ruptures (FIG. 5). The mixture of gases in the storage chamber and the hot gas produced upon deflagration of the gas generating material can combine and flow through the outflow openings of the closure structure 40 to actuate (e.g., inflate) the vehicle occupant protection device 10 (e.g., air bag).

FIG. 3 is a sectional view of the closure structure 40 of the end cap 26 in accordance with an aspect of the invention. The closure structure 40 includes an annular membrane holder 70 that defines the outflow opening 42 of the closure structure 40 and supports the membrane 44 when the membrane 44 is fastened to the membrane holder 70. The membrane holder 70 includes an outer annular wall portion 72 and an inner annular wall portion 74. The inner annular wall portion 74 extends from the outer annual wall portion 72 away from the chamber 30 (FIG. 2) and along the axis 52. The inner wall portion 74 includes an outer surface 80 that defines an annular fastening region 80 of the membrane holder 70 to which the membrane 44 is fastened.

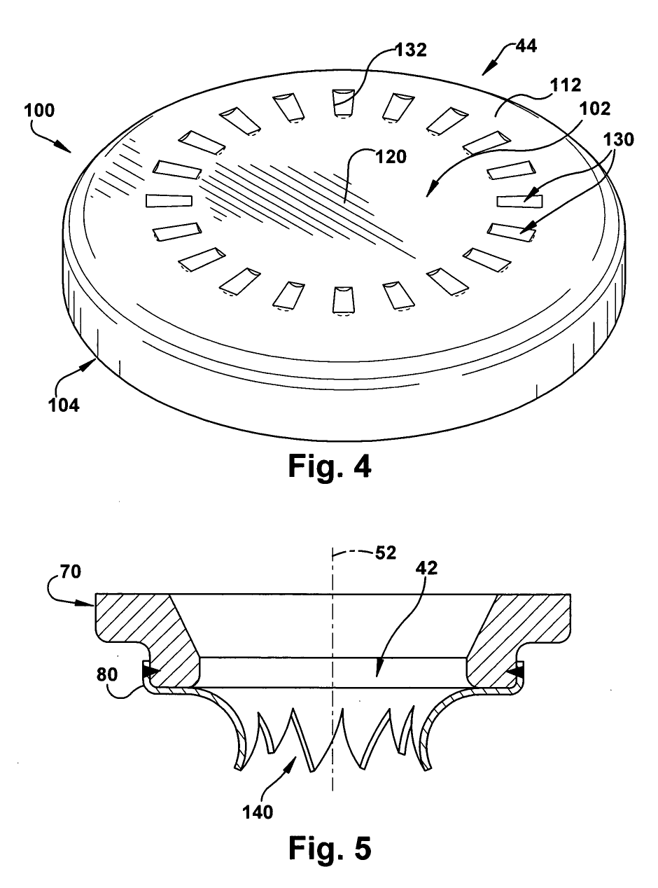

Referring also to FIG. 4, which is a perspective view of the membrane 44 in accordance with an aspect of the invention, the membrane 44 comprises a metal disc 100 with a substantially flat central portion 102 and annular outer portion 104 that extends substantially perpendicular to the central portion 102. The membrane 44 has a diameter that allows the central portion 102 and annular wall portion 104 to be seated against the fastening region 80 and close the outflow opening 42. By way of example, the diameter of the outflow opening 42 can be about 7 mm to about 10 mm (e.g., about 9 mm), and the diameter of the membrane 44 can be about 10 mm to about 15 mm (e.g., about 13 mm).

The central potion 102 has a first surface 110 and a spaced apart substantially parallel second surface 112. The first surface 110 and the second surface 112 extend radially from a center 120 of the membrane 44, which is aligned with the axis 52. When the membrane 44 is fastened to the membrane holder 70, as shown in FIG. 3, the first surface 110 faces the outflow opening and the second surface 112 faces away from the chamber 30 (FIG. 2). The membrane 44 can be fastened to the membrane holder 70 by, for example, welding the annular wall 104 of the membrane 44 to the fastening region 80 the membrane holder 70.

In accordance with an aspect of invention, the central portion 102 includes a plurality of indentations 130 that promote opening of the membrane 44 when the membrane 44 reaches an elevated temperature (e.g., at about 900° C.) and/or the pressure in the chamber 30 reaches an elevated pressure (e.g., about 24 MPa to about 100 MPa). The indentations create preset strains in the membrane 44 that promote deformation of the membrane 44 during increase in temperature of the membrane to the elevated temperature and/or increase of the fluid pressure to an elevated pressure and potentially form nominal fracture points that at least partially define the opening area (or rupture area) of the membrane 44.

The indentations 130 can be provided in at least the first surface 110 or the second surface 112 of the central portion 102 of the membrane 44 in a substantially annular pattern to ensure that the area of the opening formed after rupture of the membrane 44 is at least about 25% of the area of the outflow opening 42. The annular pattern of indentations 130 also ensures that the membrane 44 adequately opens when the inflator 20 is actuated at colder temperatures, such as less than 0° C., (e.g., about −35° C.). At colder temperatures, the pressure and, hence, the load provided by the fluid 32 can be substantially lower and may potentially affect the size of the opening in the membrane 44.

In an aspect of the invention, the indentations 130 are concentrically arranged in the second surface 112 relative to the center 120 of the membrane 44 so that after rupture of the membrane 44, as shown in FIG. 5, a substantially circular opening 140 is formed in the center of the membrane 44.

Referring again to FIG. 4, each indentation 130 can have a substantially polygonal shape (e.g., rectangular, oval, or circular) and be separated from each other indentation on the surface (110 and/or 112) of the membrane 44. The substantially polygonal shape of each indentation is defined by a depression surface 132 of the indentation 130. The depression surface 132 of each indentation is substantially annular and forms the sides of the indentation 130.

Although FIG. 4 illustrates that the shape of each indentation 130 is substantially uniform, the shape of each indentation 130 may be varied. The number of indentations 130 that are provided in the membrane 44 can also vary depending on size and shape of the membrane 44. In one example, the membrane 44 can include about 10 to about 20 indentations provided in a surface (110 and/or 112) of the membrane 44.

The minimum depth of each indentation 130 can be that depth that is sufficient to promote opening of the membrane 44. The maximum depth of each indentation 44 can be a depth that allows the membrane to sustain an increased fluid pressure when the inflator 20 is heated to a temperature of about 95° C. to about 105° C., without being actuated. By way of example, the average depth of each indentation 130 can be about 1% to about 15% of the thickness of the membrane 44 (e.g., about 5% to about 10% of the thickness of the membrane 44). By way of example, for a membrane 44 that has an average thickness of about 0.175 mm, the depth of the indentation (and the reduction in the thickness of the membrane) can be about 0.00175 mm to about 0.026 mm. This depth will vary depending on the particular metal used to form the membrane 44.

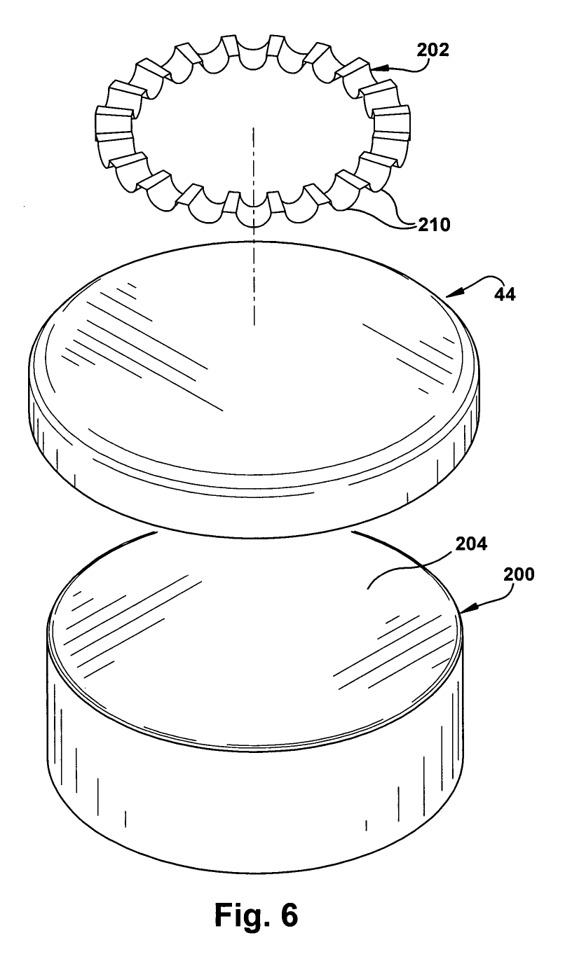

Referring to FIG. 6, the indentations 130 can be formed in a surface (110 or 112) of the membrane 44 by placing the membrane 44 on a support 200 (or die) and then stamping the membrane 44 with an indenter 202. The die 200 can have a substantially flat surface 204 that conforms to the surface (110 or 112) of the membrane 44, which rests on the die 200. The indenter 202 can include a plurality of protrusions 210 that correspond to a shape and pattern of the desired indentations 130.

The membrane 44 can be stamped with the indenter 202 at a pressure sufficient to form the indentations 130. The stamping pressure can depend on the particular metal used to form the membrane 44 as well as the desired depth of the indentations 130.

In accordance with an aspect of the invention, the membrane 44 can formed from any metal that can be readily indented with an indenter to provide indentations, welded to the membrane holder, as well as exhibits at least some plastic deformation prior to rupture. Such metals can include, for example, nickel-based alloys, such as corrosion-resistant nickel-based alloys. By “nickel-based” alloy, it is meant alloys that include at least about 50, by weight, nickel (e.g., at least about 55%, by weight, nickel).

One example of a nickel-based alloy that can be used in accordance with the invention is a corrosion-resistant nickel-chromium-molybdenum-niobium alloy that can comprise, for example up to about 22% by weight chromium and up to about 9% by weight molybdenum. Examples of nickel-chromium-molybdenum-niobium alloys include Haynes 625, which is commercially available from Haynes International, Kokomo, IN, Krupp VDM NiCr22Mo9Nb, which is commercially available from Krupp VDM GmbH, Werdohl, Germany, and UNS N06625 (i.e., “Unified Numbering System for Metals and Alloys” N06625).

Haynes 625 comprises, by weight, about 62% nickel, about 1% cobalt, about 5% iron, about 21% chromium, about 9% molybdenum, about 3.7% combined niobium and tantalum, about 0.5% manganese, about 0.5% silicon, about 0.4% aluminum, about 0.4% titanium, and about 0.1% carbon.

Krupp VDM NiCr22Mo9Nb comprises, by weight, about 62.92% nickel, about 3.15% iron, about 21.05% chromium, about 8.6% molybdenum, about 3.35% combined niobium and tantalum, about 0.14% manganese, about 0.15% silicon, about 0.13% aluminum, about 0.2% titanium, about 0.08% carbon, about 0.0005% sulfur and about 0.007% phosphorous.

UNS N06625 comprises, by weight, up to about 1% cobalt, up to about 5% iron, about 20% to about 23% chromium, about 8% to about 10% molybdenum, about 3.15% to about 4.15% combined niobium and tantalum, up to about 0.5% manganese, up to about 0.5% silicon, up to about 0.4% aluminum, up to about 0.4% titanium, up to about 0.1% carbon, up to about 0.015% sulfur, up to about 0.015% phosphorous, up to about 0.02% nitrogen, and up to about 0.30% copper.

Another example of a nickel-based alloy that can be used to form the membrane is UNS N07718. UNS N07718 comprises, by weight, about 50 to about 55% nickel, up to about 1% cobalt, about 17% to about 21% chromium, about 2.8% to about 3.3% molybdenum, about 4.75% to about 5.5% combined niobium and tantalum, up to about 0.35% manganese, up to about 0.35% silicon, about 0.2% to about 0.8% aluminum, about 0.65% to about 1.15% titanium, up to about 0.08% carbon, up to about 0.015 sulfur, up to about 0.015% phosphorous, up to about 0.006% boron, and up to about 0.30% copper.

In accordance with another aspect of the invention, the metal used to form the membrane 44 can comprise a nickel-based alloy that exhibits nearly perfect plastic behavior at temperatures to which the membrane 44 is subjected after actuation of the inflator 20. These temperature can be at least about 900° C. (e.g., about 900° C. to about 1200° C.) depending on the combustion temperature of the gas generating material employed in the inflator 20. By “nearly perfect plastic behavior”, it is meant that at the elevated temperature (e.g., about 900° C. to about 1200° C.) the nickel-based alloy's ultimate tensile strength is essentially the same (or nearly the same) as its yield strength. Nearly perfect plastic behavior at temperatures of about 900° C. to about 1200° C. can also be defined in accordance with Ramberg-Osgood's model, which has the following general equation:
σ=κεⁿ
where σ is the true stress of the nickel-based alloy, ε is the true plastic strain of the nickel-based alloy, κ is a material constant of the nickel-based alloy, and n is the strain hardening index of the alloy. Nickel-based alloys in accordance with the present invention that have nearly perfect plastic behavior have a strain hardening index less than about 0.2 (e.g., less than about 0.18) at temperatures of about 900° C. to about 1200° C.

A membrane 44 formed from a nickel-based alloy exhibiting nearly perfect plastic deformation at temperatures of at least about 900° C. can more readily open in a controlled manner to a desired opening size (e.g., greater than about 25% of the outflow opening area) and produce fewer fragments and/or particles upon rupture. Additionally, a membrane 44 formed from a nickel-based alloy exhibiting nearly perfect plastic deformation at temperatures of at least about 900° C. can be formed without indentations 130 and still open to the desired opening size.

An example of a nickel-based alloy that exhibits nearly perfect plastic deformation at temperatures of at least about 900° C. is UNS 06230 (e.g., Inconel 230). UNS 06230 is a nickel-chromium-molybdenum-tungsten alloy that comprises, by weight, at least about 50 nickel, at least about 20% chromium, up to about 3% molybdenum, and at least about 10% tungsten. UNS 06230 is commercially available from Special Metal Corporation (New Hartford, N.Y.) as Inconel 230. Inconel 230 has a nominal composition that comprises, by weight, up to about 5% cobalt, up to about 0.3% iron, about 20% to about 24% chromium, about 1% to about 3% molybdenum, about 13% to about 15% tungsten, about 0.3% to about 1% manganese, about 0.25 to about 0.75% silicon, about 0.2% to about 0.5% aluminum, about 0.05% to about 0.15% carbon, up to about 0.015% sulfur, up to about 0.03% phosphorous, and the balance substantially nickel.

In an aspect of the invention, the nickel-based alloy exhibiting nearly perfect plastic behavior can consist essentially of, by weight, up to about 5% cobalt, up to about 0.3% iron, about 20% to about 24% chromium, about 1% to about 3% molybdenum, about 13% to about 15% tungsten, about 0.3% to about 1% manganese, about 0.25 to about 0.75% silicon, about 0.2% to about 0.5% aluminum, about 0.05% to about 0.15% carbon, up to about 0.015% sulfur, up to about 0.03% phosphorous, up to about 0.25% residual elements, and the balance nickel. By residual elements, it is meant the combined weight of additional elements including, for example, boron, niobium, lanthanum, tantalum, and nitrogen.

Inconel 230 has a high tungsten content compared to other nickel-based alloys used to form the membrane. The high tungsten content improves the alloys resistance to pitting and crevice corrosion. Inconel 230 also has a fully austenitic microstructure. By virtue of the Inconel 230's carbon content, the microstructure contains quantities of secondary carbide particles (e.g., M₆C and M₂₃C₆) that contribute substantially to the alloy's strength. The microstructure of Inconel 230 does not exhibit sigma phase (i.e., nickel-chromium-molybdenum precipitation), mu phase (i.e., nickel-iron-molybdenum precipitation) or other deleterious phase formation at high temperatures (e.g., at least about 900° C.).

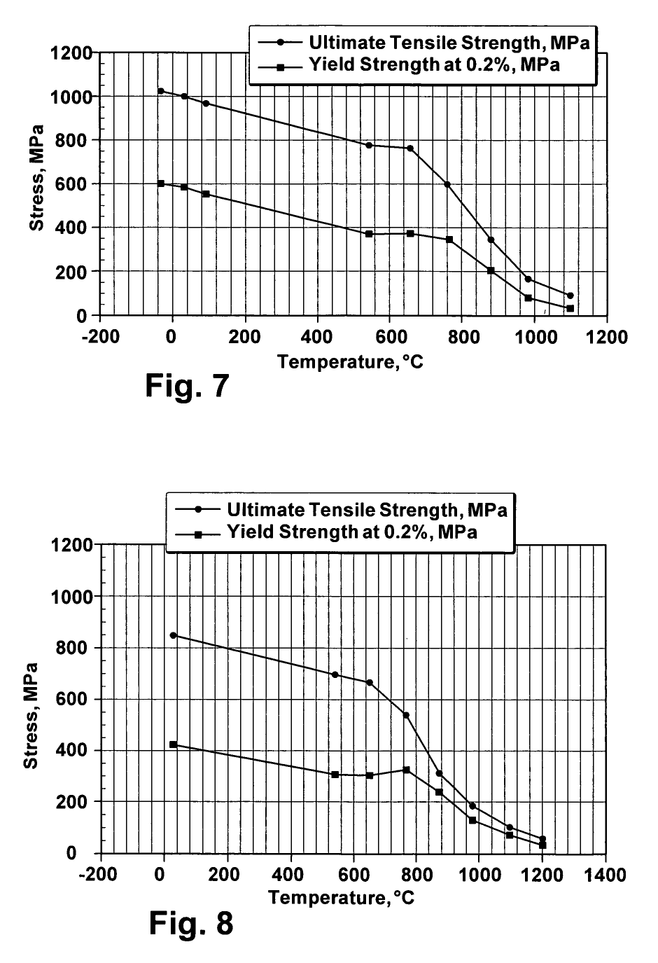

FIGS. 8 and 7 are plots showing the ultimate tensile strength and yield strength of sheets of, respectively, Inconel 230 and Inconel 625, a nickel-based alloy substantially the same as the UNS N06625 described above. Inconel 625 has a nominal composition that consists essentially of, by weight, up to about 5% iron, about 20% to about 23% chromium, about 8% to about 10% molybdenum, about 3.15% to about 4.15% combined niobium and tantalum, up to about 0.5% manganese, up to about 0.5% silicon, up to about 0.4% aluminum, up to about 0.4% titanium, up to about 0.1% carbon, up to about 0.015% sulfur, up to about 0.015% phosphorous, up to about 0.02% nitrogen, up to about 0.3% copper, and the balance nickel.

As shown in FIG. 8, at temperatures above about 900° C., Inconel 230 has an ultimate tensile strength and a yield strength that are substantially the same, which is indicative of nearly perfect plastic deformation. In contrast, as shown in FIG. 7, at temperatures above about 900° C., Inconel 625 has an ultimate tensile strength and a yield strength that differ so as not to exhibit nearly perfect plastic deformation.

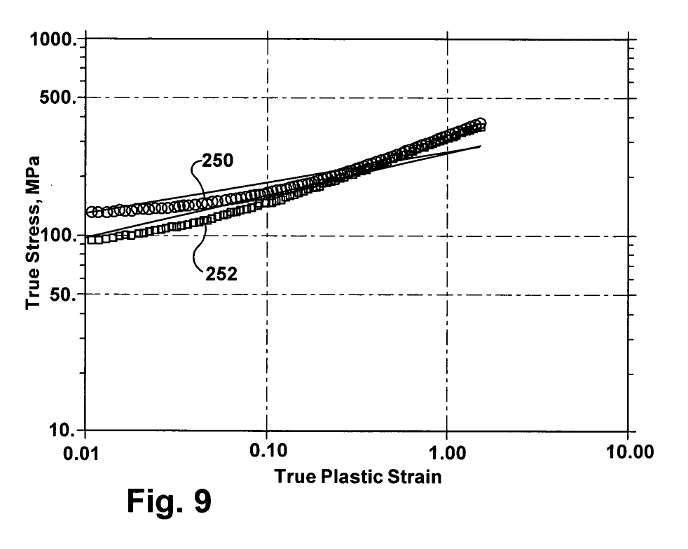

The nearly perfect plastic behavior exhibited by Inconel 230 compared to Inconel 625 is also shown in FIG. 9. FIG. 9 illustrates log-log plots 250 and 252 of the true plastic strain with respect to the true stress (MPa) for, respectively, Inconel 230 and Inconcel 625. The slope of the plots 250 and 252 represents the strain hardening index in accordance with Ramberg-Osgood's model. A more horizontal slope represents a lower hardening index, and, hence, a more perfect plastic behavior. Inconel 230 has a hardening index of about 0.16, and Inconel 625 has a hardening index of about 0.22. The slope of plot 250 for Inconel 230 is substantially more horizontal than the slope of plot 252 for Inconel 625, which is indicative of the nearly plastic behavior of Inconel 230.

From the above description of the invention, those skilled in the art will perceive improvements, changes and modifications. Examples of changes include changes in the inflator construction. For example, the combustion chamber can be provided in the chamber 30 used to store the gas 32. Thus, upon actuation of the inflator, the deflgration gas increases the pressure of the stored gas 31 in the chamber to an elevated pressure (e.g., about 24 MPa to about 100 Mpa) that can cause the membrane to rupture. Additionally, the inflator can have a construction similar to the inflator construction in U.S. Pat. Nos. 5,348,344 and 5,786,543, which are herein incorporated by reference in their entirety. The inflators in these patents include a fuel gas (e.g., H₂) and an oxidizer gas (O₂) instead of solid gas generating material, as described with respect to the present invention. Such improvements, changes and modifications within the skill of the art are intended to be covered by the appended claims.

Having described the invention, the following is claimed:

1. An apparatus for actuating a vehicle occupant protection device comprising:
a housing having a chamber containing a fluid at a first pressure;
an outflow opening in the housing through which the fluid can flow from the housing to actuate the vehicle occupant protection device;
and a membrane having a first temperature that closes the opening, the membrane including a surface extending across the opening, the surface including a plurality of indentations concentrically arranged relative to a center of the surface, each indentation having a substantially polygonal shape and being separated from each other indentation on the surface.

2. The apparatus of claim 1, the indentations having an average depth, the average depth being about 1% to about 15% of a thickness of the membrane.

3. The apparatus of claim 1, the indentations promoting rupturing of the membrane when the fluid reaches an elevated pressure and/or when the membrane reaches an elevated temperature.

4. The apparatus of claim 2, the membrane rupturing when the pressure of the fluid is elevated to a pressure between about 24 MPa and about 100 Mpa and/or the membrane is heated to a temperature of at least about 900° C.

5. The apparatus of claim 1, the membrane comprising a nickel-based alloy.

6. The apparatus of claim 5, the nickel-based alloy having a strain hardening index at temperatures of about 900° C. to about 1200° C. defined by:
σ=κεⁿ
where σ is the true stress of the nickel-based alloy, ε is the true plastic strain of the nickel-based alloy, κ is a material constant of the nickel-based alloy, and n is the strain hardening index of the nickel-based alloy, the strain hardening index of the nickel-based alloy being less than about 0.2.

7. The apparatus of claim 6, the nickel-based alloy comprising, by weight, up to about 5% cobalt, up to about 0.3% iron, about 20% to about 24% chromium, about 1% to about 3% molybdenum, about 13% to about 15% tungsten, about 0.3% to about 1% manganese, about 0.25 to about 0.75% silicon, about 0.2% to about 0.5% aluminum, about 0.05% to about 0.15% carbon, up to about 0.015% sulfur, up to about 0.03% phosphorous, and the balance substantially nickel.

8. An inflator for inflating a vehicle occupant protection device comprising:
a housing having a chamber containing a fluid at a first pressure;
an outflow opening in the housing through which the fluid can flow from the housing to inflate the vehicle occupant protection device;
and a membrane having a first temperature that closes the opening, the membrane including a surface extending across the opening, the surface including a plurality of indentations concentrically arranged relative to a center of the surface, each indentation having a substantially polygonal shape and being separated from each other indentation on the surface, the membrane being formed from a nickel-based alloy and being rupturable when the stored fluid reaches an elevated pressure and/or when the membrane reaches an elevated temperature, the elevated pressure being substantially greater than the first pressure and the elevated temperature being substantially greater than the first temperature.

9. The inflator of claim 8, the indentations having an average depth, the average depth being about 1% to about 15% of a thickness of the membrane.

10. The inflator of claim 9, the indentations promoting rupturing of the membrane when the fluid reaches the elevated pressure and/or the membrane reaches the elevated temperature.

11. The inflator of claim 10, the elevated pressure being between about 24 Mpa and about 100 Mpa and the elevated temperature being greater than about 900° C.

12. The inflator of claim 8, the membrane comprising a nickel-based alloy, the nickel-based alloy having a strain hardening index at temperatures of about 900° C. to about 1200° C. defined by:
σ=κεⁿ
where σ is the true stress of the nickel-based alloy, ε is the true plastic strain of the nickel-based alloy, κ is a material constant of the nickel-based alloy, and n is the strain hardening index of the nickel-based alloy, the strain hardening index of the nickel-based alloy being less than about 0.2.

13. The inflator of claim 8, the membrane comprising a nickel-based alloy, the nickel-based alloy comprising, by weight, up to about 5% cobalt, up to about 0.3% iron, about 20% to about 24% chromium, about 1% to about 3% molybdenum, about 13% to about 15% tungsten, about 0.3% to about 1% manganese, about 0.25 to about 0.75% silicon, about 0.2% to about 0.5% aluminum, about 0.05% to about 0.15% carbon, up to about 0.015% sulfur, up to about 0.03% phosphorous, and the balance substantially nickel.

14. A method of forming a rupturable disc for an inflator of a vehicle occupant protection apparatus, the method comprising:
providing a metal disc, the metal disc having a radially extending first surface, a radially extending second surface spaced apart from the first surface, a diameter that allows the disc to cover an outflow opening of a housing of the inflator of the vehicle occupant protect apparatus and a thickness that provides the disc with a rupture pressure between about 24 Mpa and about 100 Mpa;
providing a plurality of indentations in at least one of the first surface and the second surface of the disc, each indentation having a substantially polygonal shape and being separated from each other indentation, the indentations being concentrically arranged about a center of the disc.

15. The method of claim 14, the disc comprising a nickel-based alloy, the nickel-based alloy having a strain hardening index at temperatures of about 900° C. to about 1200° C. defined by:
σ=κεⁿ
where σ is the true stress of the nickel-based alloy, ε is the true plastic strain of the nickel-based alloy, κ is a material constant of the nickel-based alloy, and n is the strain hardening index of the nickel-based alloy, the strain hardening index of the nickel-based alloy being less than about 0.2.

16. An apparatus comprising:
a housing containing a fluid at a first pressure, a portion of the housing comprising a nickel-based alloy, the nickel-based alloy having a strain hardening index at temperatures of about 900° C. to about 1200° C. defined by:
σ=κεⁿ
where σ is the true stress of the nickel-based alloy, ε is the true plastic strain of the nickel-based alloy, κ is a material constant of the nickel-based alloy, and n is the strain hardening index of the nickel-based alloy, the strain hardening index of the nickel-based alloy being less than about 0.2.

17. The apparatus of claim 16, the nickel-based alloy having a microstructure, the microstructure being substantially free of sigma phase and mu phase at temperatures above about 900° C.

18. The apparatus of claim 16, the nickel-based alloy comprising, by weight, at least about 50 nickel, at least about 20% chromium, up to about 3% molybdenum, and at least about 10% by weight tungsten.

19. The apparatus of claim 16, the nickel-based alloy comprising, by weight, up to about 5% cobalt, up to about 0.3% iron, about 20% to about 24% chromium, about 1% to about 3% molybdenum, about 13% to about 15% tungsten, about 0.3% to about 1% manganese, about 0.25 to about 0.75% silicon, about 0.2% to about 0.5% aluminum, about 0.05% to about 0.15% carbon, up to about 0.015% sulfur, up to about 0.03% phosphorous, and the balance substantially nickel.

20. The apparatus of claim 16, the nickel-based alloy consisting essentially of, by weight, up to about 5% cobalt, up to about 0.3% iron, about 20% to about 24% chromium, about 1% to about 3% molybdenum, about 13% to about 15% tungsten, about 0.3% to about 1% manganese, about 0.25 to about 0.75% silicon, about 0.2% to about 0.5% aluminum, about 0.05% to about 0.15% carbon, up to about 0.015% sulfur, up to about 0.03% phosphorous, up to about 0.25% residual elements, and the balance nickel.

21. The apparatus of claim 16, further comprising an outflow opening in the housing through which the fluid can emerge,
and a membrane having a first temperature that closes the opening, the membrane being formed from the nickel-based alloy and being rupturable when the stored fluid reaches an elevated pressure and/or the membrane reaches an elevated temperature, the elevated pressure and elevated temperature being substantially greater than the first pressure and first temperature and substantially less than the pressure and temperature at which the housing ruptures.

22. The apparatus of claim 21, the membrane including a first surface facing the opening and a second surface facing an interior of the chamber.

23. The apparatus of claim 22, at least one of the first surface and the second surface including a plurality of indentations, the plurality of indentations promoting rupturing of the membrane when the fluid reaches the elevated pressure.

24. The apparatus of claim 22, the indentations being concentrically arranged relative to a center of at least one of the first surface or second surface of the membrane.

25. An apparatus for actuating a vehicle occupant protection device comprising:
a housing having a chamber containing a fluid at a first pressure,
an outflow opening in the housing through which the fluid can flow from the housing to actuate the vehicle occupant protection device,
and a membrane having a first temperature that closes the opening, the membrane comprising a nickel-based alloy, the nickel-based alloy having a strain hardening index at temperatures of about 900° C. to about 1200° C. defined by:
σ=κεⁿ
where σ is the true stress of the nickel-based alloy, ε is the true plastic strain of the nickel-based alloy, κ is a material constant of the nickel-based alloy, and n is the strain hardening index of the nickel-based alloy, the strain hardening index of the nickel-based alloy being less than about 0.2.

26. The apparatus of claim 25, the nickel-based alloy comprising, by weight, at least about 50 nickel, at least about 20% chromium, up to about 3% molybdenum, and at least about 10% by weight tungsten.

27. The apparatus of claim 25, the nickel-based alloy comprising, by weight, up to about 5% cobalt, up to about 0.3% iron, about 20% to about 24% chromium, about 1% to about 3% molybdenum, about 13% to about 15% tungsten, about 0.3% to about 1% manganese, about 0.25 to about 0.75% silicon, about 0.2% to about 0.5% aluminum, about 0.05% to about 0.15% carbon, up to about 0.015% sulfur, up to about 0.03% phosphorous, and the balance substantially nickel.

28. The apparatus of claim 25, the membrane being rupturable when the stored fluid reaches an elevated pressure and/or the membrane reaches an elevated temperature, the elevated pressure being substantially greater than the first pressure, the elevated temperature being substantially greater than the first temperature.

29. The apparatus of claim 28, the membrane including a first surface facing the opening and a second surface facing an interior of the chamber.

30. The apparatus of claim 29, at least one of the first surface and the second surface including a plurality of indentations, the plurality of indentations promoting rupturing of the membrane when the fluid reaches the elevated pressure.

31. The apparatus of claim 30, the indentations being concentrically arranged relative to a center of at least one of the first surface and the second surface of the membrane.
